(19) United States
(12) Patent Application Publication
(10) Pub. No.: US 2026/0125003 A1
(43) Pub. Date: May 7, 2026

(54) VEHICULAR INTERIOR COMPONENT

(71) Applicants: TOYOTA BOSHOKU KABUSHIKI KAISHA, Aichi-ken (JP); TOYOTA JIDOSHA KABUSHIKI KAISHA, Aichi-ken (JP)

(72) Inventors: Kurato KAMADA, Seto-shi (JP); Isao SHINAGAWA, Toyota-shi (JP)

(73) Assignees: TOYOTA BOSHOKU KABUSHIKI KAISHA, Aichi-ken (JP); TOYOTA JIDOSHA KABUSHIKI KAISHA, Aichi-ken (JP)

(21) Appl. No.: 19/374,584

(22) Filed: Oct. 30, 2025

(30) Foreign Application Priority Data
Nov. 5, 2024 (JP) 2024-193467

(51) Int. Cl. B60R 13/08

(52) U.S. Cl. CPC B60R 13/0823

(57) ABSTRACT

A vehicular interior component includes an interior component body member having a plate shape and including a compartment interior side surface, a compartment exterior side surface, and through holes, a net member disposed on the compartment interior side surface of the interior component body member, and a reinforcing member mounted on the compartment exterior side surface of the interior component body member. The reinforcing member includes a reinforcing body portion having an interior component body side surface that faces the interior component body and includes projections that project from the interior component body side surface toward the interior component body and are inserted through the through holes of the interior component body member. The projections include stopper portions at projecting end portions of the projections and the stopper portions are on a compartment interior side with respect to the interior component body member and holding the net member.

### CROSS REFERENCE TO RELATED APPLICATION

This application claims priority from Japanese Patent Application No. 2024-193467 filed on November 5, 2024. The entire contents of the priority application are incorporated herein by reference.

### TECHNICAL FIELD

The technology described herein relates to a vehicular interior component.

### BACKGROUND

A vehicular interior component as one example includes an interior component body member (a side pocket trim) having a plate shape and including a recessed portion, a net member covering the recessed portion, and a stopper member (a hook) for holding the net member. Items can be stored in a space between the net member and the interior component body member.

In the above configuration, the stopper members are disposed along an opening edge of the recessed portion and each of the stopper members is fixed to the interior component body member with a screw. This increases the number of processes for fixing the stopper members.

### SUMMARY

An object of the technology described herein is to provide a vehicular interior component that is reduced in the number of processes for mounting stopper members, which are for holding a net member, to an interior component body member.

A vehicular interior component according the technology described herein includes an interior component body member having a plate shape and including a compartment interior side surface, a compartment exterior side surface, and through holes, a net member disposed on the compartment interior side surface of the interior component body member, and a reinforcing member mounted on the compartment exterior side surface of the interior component body member. The reinforcing member includes a reinforcing body portion having an interior component body side surface that faces the interior component body and includes projections that project from the interior component body side surface toward the interior component body member and are inserted through the through holes of the interior component body member. The projections include stopper portions at projecting end portions of the projections and the stopper portions are on a compartment interior side with respect to the interior component body member and holding the net member.

### BRIEF DESCRIPTION OF THE DRAWINGS

FIG. 1 is a side view of a vehicle that includes a room partition trim according to one embodiment.

FIG. 2 is a perspective view illustrating the room partition trim seen from a vehicular compartment interior side (a vehicular front side).

FIG. 3 is a perspective view illustrating a trim body member seen from the vehicular compartment interior side.

FIG. 4 is a perspective view illustrating the room partition member seen from a vehicular compartment exterior side (a vehicular rear side).

FIG. 5 is an enlarged perspective view illustrating a portion of FIG. 4 near the reinforcing member 60.

FIG. 6 is a perspective view illustrating the reinforcing member 60 seen from the vehicular compartment interior side.

FIG. 7 is an elevation view illustrating a portion of the room partition trim near a net member.

FIG. 8 is a cross-sectional view illustrating projections 66, 67 taken along line VIII-VIII in FIG. 7.

FIG. 9 is a cross-sectional view illustrating a middle projection 67 taken along line IX-IX in FIG. 7.

FIG. 10 is a cross-sectional view illustrating a fitting recessed portion taken along line X-X in FIG. 7.

### DETAILED DESCRIPTION

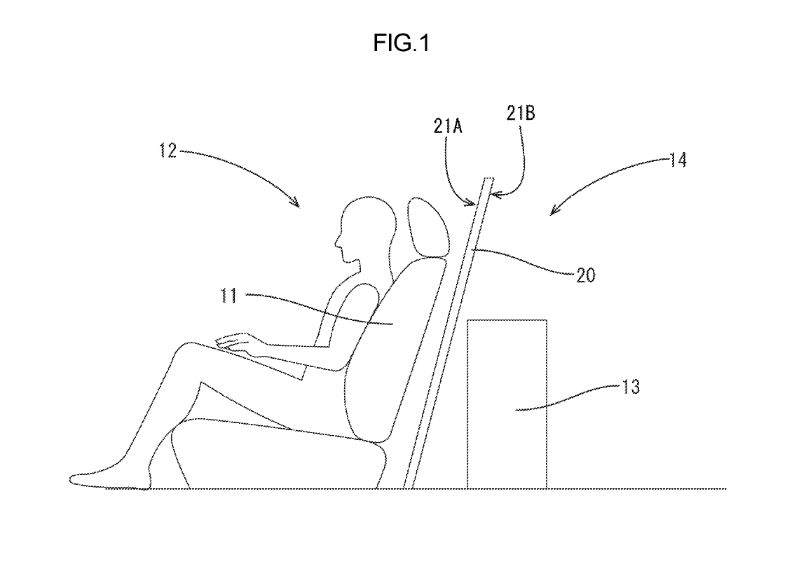

A room partition trim 20 for a vehicle will be described with reference to FIGS. 1 to 10 as one example of a vehicular interior component. As illustrated in FIG. 1, the room partition trim 20 defines a vehicular compartment 12 including a seat 11 where a passenger is seated and a storage room 14 in which a device 13 installed in the vehicle such as a battery is disposed. The device 13 is covered by a metal panel member from a vehicular front side (a left side in FIG. 1) and the room partition trim 20 is disposed to cover the panel member from the vehicular front side.

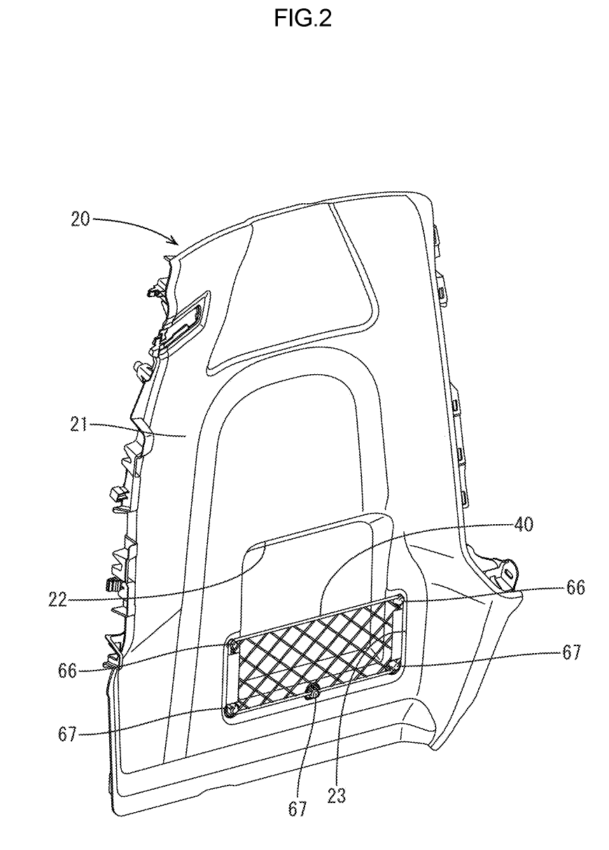

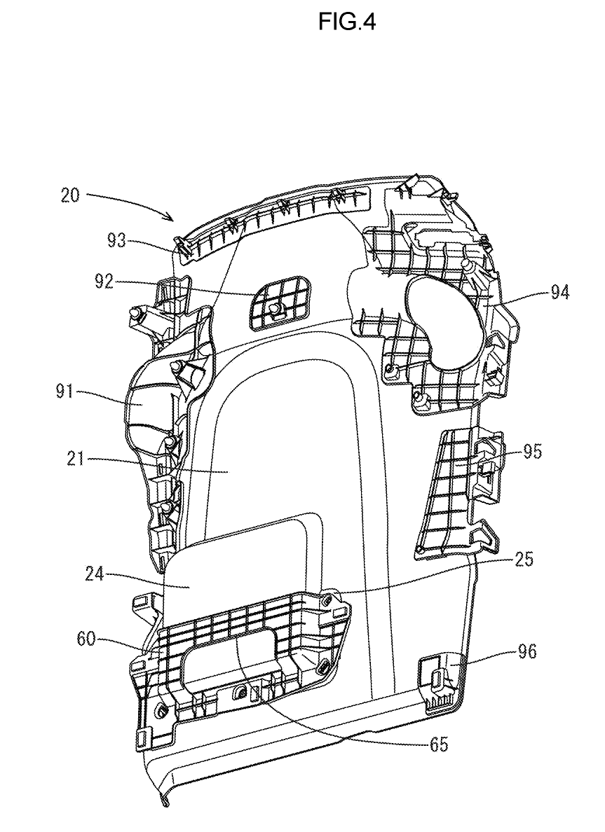

As illustrated in FIGS. 2 and 4, the room partition trim 20 includes a trim body member 21 (an interior component body member) having a plate shape, a net member 40 that is disposed on a compartment interior side surface 21A (a surface opposite the seat 11, a first surface) of the trim body member 21, and reinforcing members 60, 91, 92, 93, 94, 95 that are attached to a compartment exterior side surface 21B (a surface opposite the device 13, a second surface) of the trim body member 21. The compartment exterior side surface 21B is an opposite surface from the compartment interior side surface 21A.

The trim body member 21 is obtained by integrally molding a synthetic resin sheet (made of polypropylene, for instance) and a skin member (a decoration member) with heat pressing. With the trim body member 21 being produced with press molding, it is not easy to form ribs for increasing rigidity on a surface of the trim body member. In this embodiment, reinforcing members 60, 91, 92, 93, 94, 95 are attached to the trim body member 21 to increase rigidity.

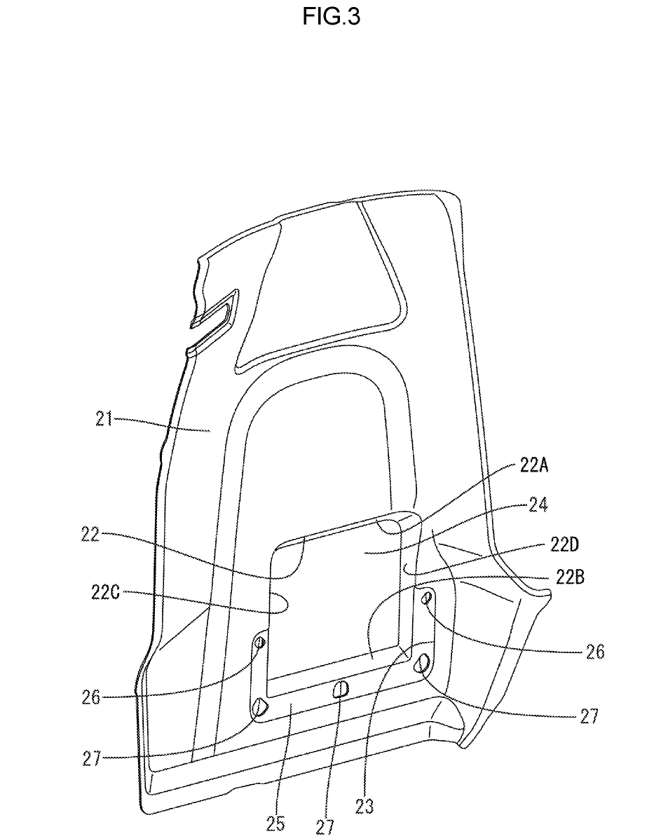

As illustrated in FIGS. 2 and 3, the trim body member 21 includes a first recessed portion 22 and a second recessed portion 23 on a lower portion of a compartment interior side surface 21A (the first surface) of the trim body member 21. The first recessed portion 22 and the second recessed portion 23 open toward the net member 40. The first recessed portion 22 has a square front view shape. The second recessed portion 23 is on a lower half portion of an opening edge portion of the first recessed portion 22. The recessed depth of the second recessed portion 23 is smaller than that of the first recessed portion 22. The second recessed portion 23 is continuous from the first recessed portion 22 to form a step.

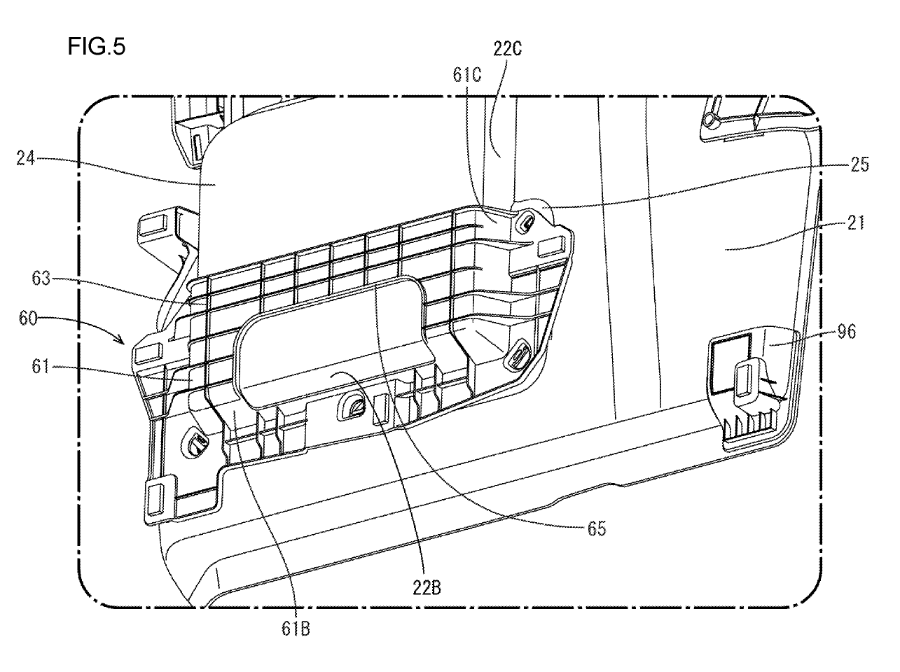

As illustrated in FIG. 2, the net member 40 has a laterally long rectangular shape and has elasticity. The net member 40 is attached to the trim body member 21 at the second recessed portion 23 and covers a lower portion of the first recessed portion 22. With such a configuration, an item can be stored in a space between the trim body member 21 and the net member 40. As illustrated in FIGS. 4 and 5, the first recessed portion 22 is a portion of the trim body member 21 that is recessed (projects) toward the reinforcing member 60 side (a compartment exterior side, the compartment exterior side surface 21B side, toward the device 3). As illustrated in FIG. 3, the first recessed portion 22 includes a bottom wall portion 24, an upper wall portion 22A, a lower wall portion 22B, and side wall portions 22C, 22D. The upper wall portion 22A, the lower wall portion 22B, and the side wall portions 22C, 22D extend from peripheral edges of the bottom wall portion 24. The second recessed portion 23 is a portion of the trim body member 21 that is recessed toward the reinforcing member 60 side. The second recessed portion 23 includes a bottom wall portion 25.

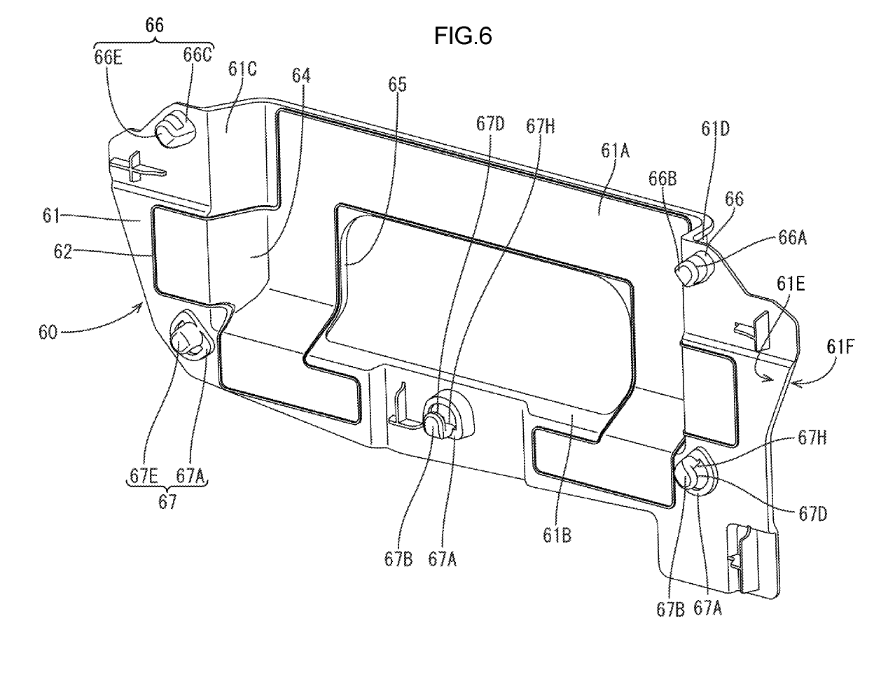

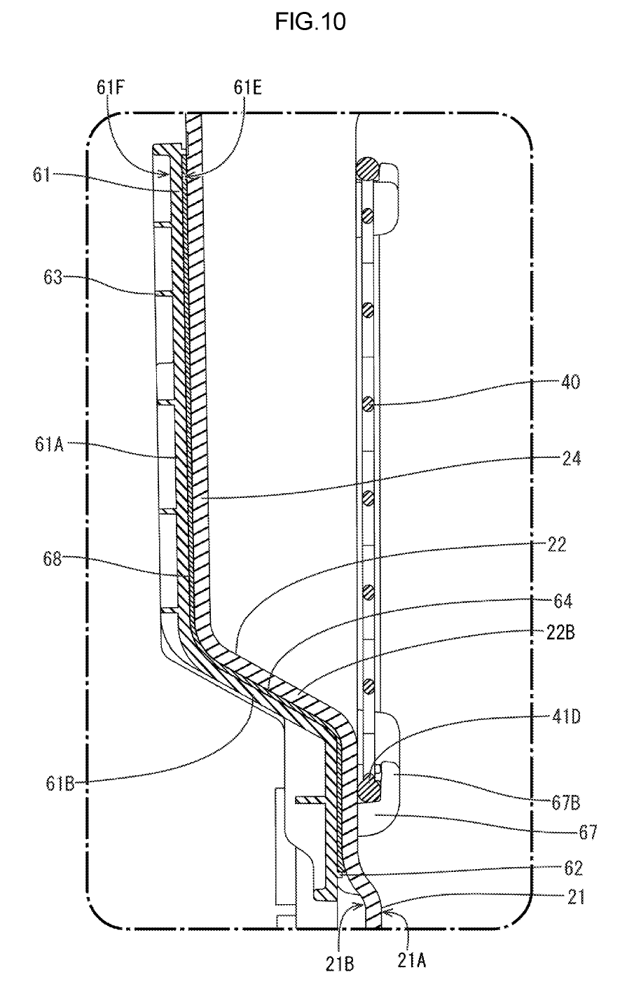

As illustrated in FIGS. 5 and 6, the reinforcing member 60 includes a reinforcing body portion 61 having a plate shape, a rib 62 having a ring shape and disposed on a compartment interior side surface 61E (an interior component body side surface) of the reinforcing body portion 61, and a rib 63 having a grid pattern and disposed on a compartment exterior side surface 61F of the reinforcing body portion 61. The compartment interior side surface 61E of the reinforcing body portion 61 faces the trim body member 21 and the compartment exterior side surface 61F is an opposite surface from the compartment interior side surface 61E. As illustrated in FIGS. 6 and 10, the reinforcing body portion 61 includes a fitting recessed portion 64 that is fitted to a lower portion of the first recessed portion 22. The reinforcing body portion 61 is disposed to cover the lower portion of the first recessed portion 22 from the compartment exterior side that is opposite from the opening side of the first recessed portion 22. The fitting recessed portion 64 is a portion of the reinforcing body portion 61 that is recessed toward the compartment exterior side. As illustrated in FIG. 6, the fitting recessed portion 64 of the reinforcing body portion 61 includes a bottom wall portion 61A, a lower wall portion 61B, and side wall portions 61C, 61D that extend from peripheral edges of the bottom wall portion 61A. The fitting recessed portion 64 includes a through hole 65 in portions of the bottom wall portion 61A and the lower wall portion 61B that are continuous to each other. As illustrated in FIGS. 5 and 10, with the reinforcing member 60 being attached to the trim body member 21, the lower wall portion 61B is contacted with the lower wall portion 22B and the bottom wall portion 61A is contacted with a lower portion of the bottom wall portion 24, and the side wall portions 61C, 61D are contacted with the side wall portions 22C, 22D, respectively.

As illustrated in FIG. 10, adhesive 68 (such as hot melt adhesive) is disposed on a portion of the compartment interior side surface 61E of the reinforcing body portion 61 that is surrounded by the rib 62 and the reinforcing member 60 is bonded to the compartment exterior side surface 21B of the trim body member 21 with the adhesive 68. With the adhesive 68 being disposed on the portion inside the ring-shaped rib 62, the adhesive 68 is surely disposed on a predefined portion.

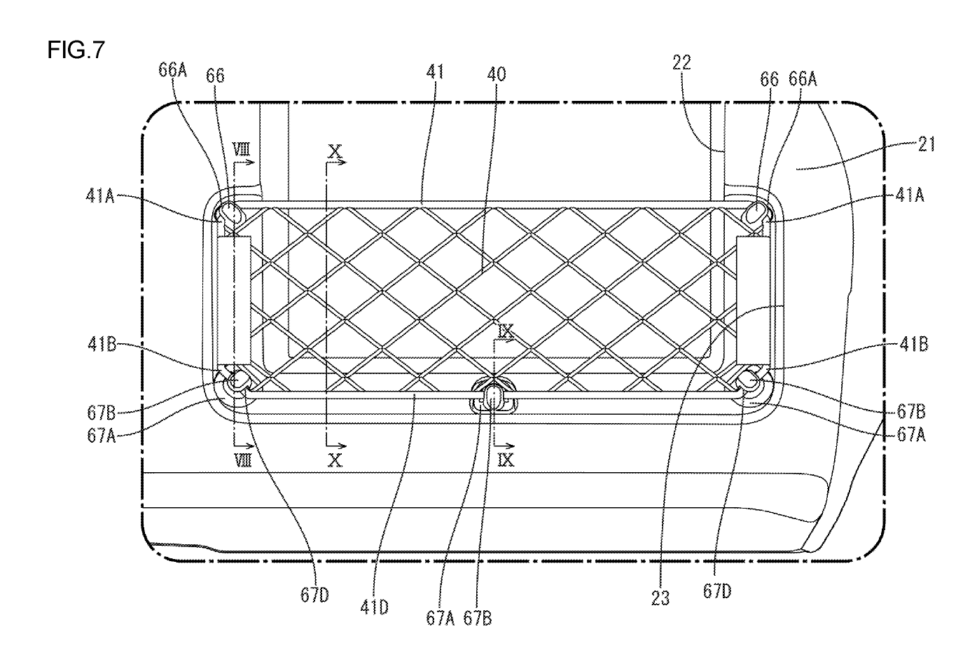

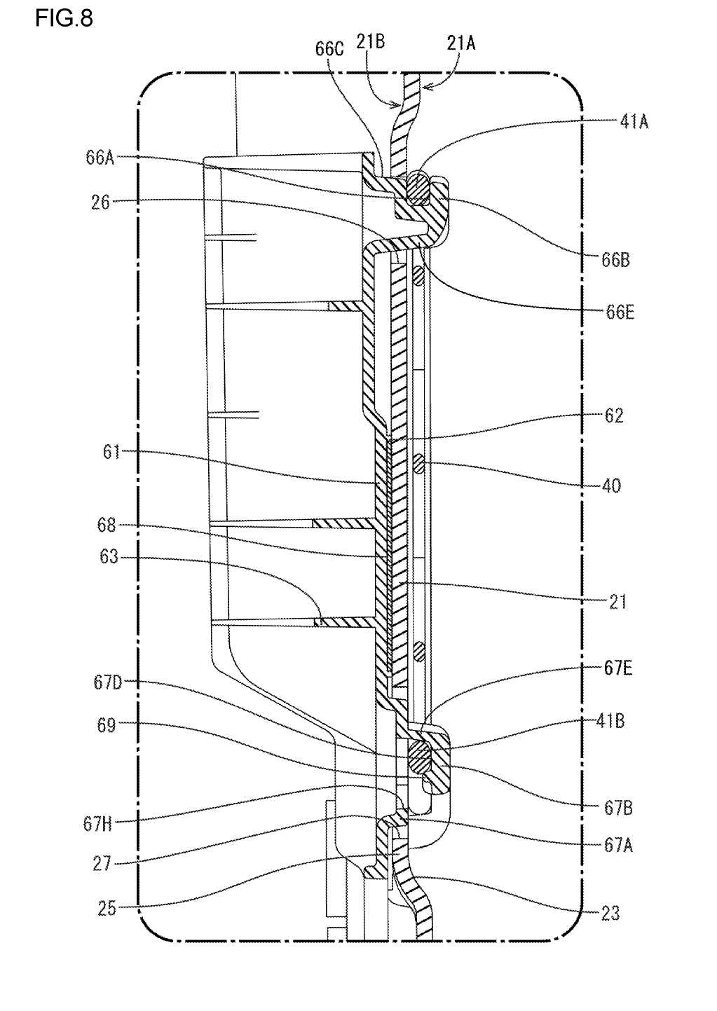

As illustrated in FIG. 6, the reinforcing body portion 61 integrally includes projections 66, 67 on the compartment interior side surface 61E that faces the trim body member 21. The projections 66, 67 project from the compartment interior side surface 61E of the reinforcing body portion 61, which faces the trim body member 21, toward the trim body member 21. As illustrated in FIG. 7, the projections 66, 67 are for holding a peripheral portion 41 of the net member 40. The projections 66, 67 are on a portion of the reinforcing body portion 61 near an opening edge of the fitting recessed portion 64. As illustrated in FIG. 8, the projections 66 on an upper portion of the reinforcing body portion 61 are fitted in through holes 26 in the bottom wall portion 25 of the second recessed portion 23 of the trim body member 21.

The projections 66 are inserted through the through holes 26 toward the trim body member 21. As illustrated in FIGS. 6 and 8, the projection 66 includes a base portion 66C and a projecting end portion 66E. The base portion 66C is continuous from the reinforcing body portion 61 and on the compartment exterior side surface 21B side of the trim body member 21. The projecting end portion 66E includes a recess 66A that opens obliquely upward and a stopper portion 66B that is a wall portion of the recess 66A. The projecting end portion 66E is on the compartment interior side surface 21A side of the trim body member 21. As illustrated in FIGS. 7 and 8, corner portions 41A of the peripheral portion 41 of the net member 40 are fitted in the recesses 66A. The recces 66A includes the stopper portion 66B at the opening edge of the recess 66A and the corner portion 41A of the net member 40 is held by the stopper portion 66B.

As illustrated in FIG. 6, the projections 67 on a lower portion of the reinforcing body portion 61 are inserted through the through holes 27 toward the trim body member 21. As illustrated in FIGS. 6 and 8, the projection 67 includes a base portion 67A and a projecting end portion 67E. The base portion 67A is continuous from the reinforcing body portion 61 and on the compartment exterior side surface 21B side of the trim body member 21. The projecting end portion 67E includes a recess 67D and a stopper portion 67B that project from the base portion 67A. The projecting end portion 67E is on the compartment interior side surface 21A side of the trim body member 21. As illustrated in FIG. 8, the base portion 67A is fitted in the through hole 27 in the bottom wall portion 25 of the second recessed portion 23 of the trim body member 21. The projections 67 project through the through holes 27 toward the trim body member 21. The projections 67 include the stopper portions 67B at the projecting end portions thereof. The projecting end portions 67E are bent to have an L shape. The stopper portions 67B are on the compartment interior side of the trim body member 21. Corner portions 41B of the net member 40 are held by the stopper portions 67B.

As illustrated in FIG. 6, three projections 67 are arranged along the vehicular width direction and two projections 67 at ends are disposed such that the recesses 67D open obliquely downward. Namely, the stopper portions 67B extend such that the distal ends thereof are directed obliquely downward. Accordingly, as illustrated in FIG. 8, the base portion 67A and the stopper portion 67B of the projections 67 at ends are configured as the recess 67D that opens obliquely downward. The corner portions 41B of the of the peripheral portion 41 of the net member 40 are in the recesses 67D.

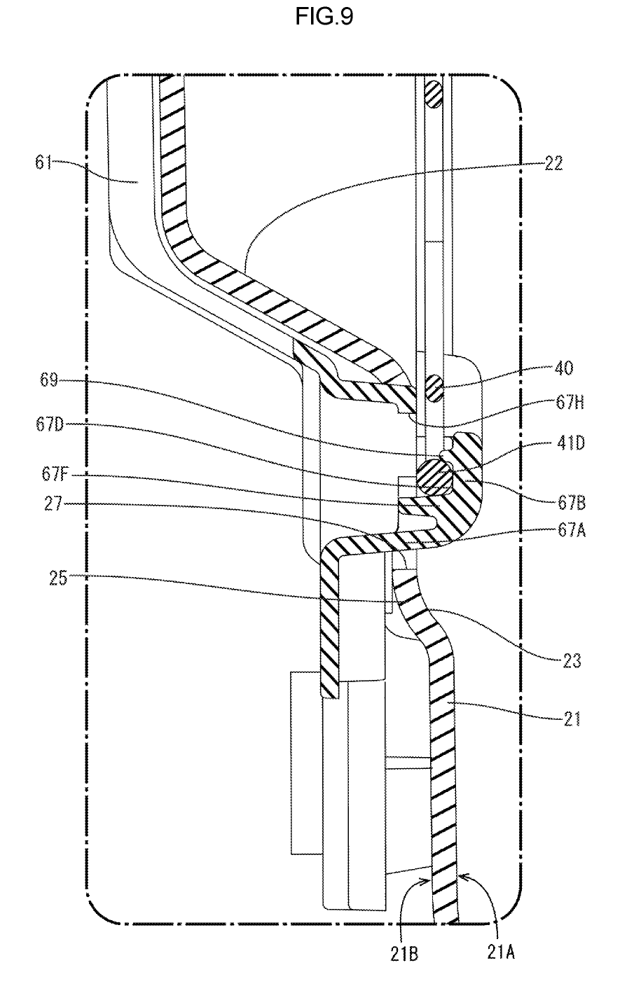

As illustrated in FIG. 6, one of the three projections 67 disposed in a middle includes the recess 67D that opens upward. The stopper portion 67B of the middle projection 67 extends such that the distal end thereof is directed upward. As illustrated in FIG. 9, the base portion 67A and the stopper portion 67B of the middle projection 67 are configured as the recess 67D that opens upward. A lower portion 41D of the peripheral portion 41 of the net member 40 is in the recess 67D of the middle projection 67. The basal portion 67F of the stopper portion 67B supports the lower portion 41D of the net member 40 from below. Accordingly, with an item being stored in the first recessed portion 22, the lower portion 41D of the net member 40 is less likely to be stretched downward due to the weight of the item. As illustrated in FIG. 9, the stopper portion 67B includes a projection 69 at the distal end portion. Accordingly, the peripheral portion 41 of the net member 40 is less likely to be detached from the recess 67D.

The reinforcing member 60 is made of synthetic resin and may be produced with injection molding. The projections 66 including the recesses 66A may be molded with using a slide die. On the other hand, as illustrated in FIG. 9, the base portion 67A of the projection 67 includes the through hole 67H. Therefore, the projections 67 may be molded without using a slide die.

Next, effects of this embodiment will be described. The room partition trim 20 of this embodiment includes the trim body member 21 having a plate shape, the net member 40 disposed on the compartment interior side surface 21A of the trim body member 21, and the reinforcing member 60 mounted on the compartment exterior side surface 21B of the trim body member 21. The reinforcing member 60 includes the projections 66, 67 on the compartment interior side surface 61E that faces the trim body member 21. The projections 66, 67 project from the compartment interior side surface 61E toward the trim body member 21. The projections 66, 67 are inserted through the through holes 26, 27 of the trim body member 21 such that the projecting end portions 66E, 67E of the projections 66, 67 are on the compartment interior side of the trim body member 21. The net member 40 is held by the stopper portions 66B, 67B of the projecting end portions 66E, 67E. With the projections 66, 67 being inserted through the through holes 26, 27, as illustrated in FIGS. 8 and 9, the stopper portions 66B, 67B are on one side with respect to the trim body member 21 and the reinforcing body portion 61 is on an opposite side from the one side with respect to the trim body member 21. Namely, the stopper portions 66B, 67B and the reinforcing body portion 61 are on opposite sides with respect to the trim body member 21.

With the reinforcing member 60, rigidity of the portion of the trim body member 21 corresponding to the net member 40 is increased and the trim body member 21 is less likely to be deformed when an item is put in and taken out of the space between the net member 40 and the trim body member 21. The net member 40 is attached to the trim body member 21 with being held by the stopper portions 66B, 67B of the projecting end portions 66E, 67E of the projections 66, 67. The reinforcing member 60 includes the projections 66, 67. Therefore, with the reinforcing member 60 being attached to the trim body member 21, the projections 66, 67 are fixed with respect to the trim body member 21. With such a configuration, the number of mounting processes can be reduced compared to the configuration in which the projections (the stopper portions) are separately attached to the trim body member. The projections 66, 67 are inserted through the through holes 26, 27 of the trim body member 21, respectively. With such a configuration, the projections 66, 67 can be supported in the through holes 26, 27. Therefore, the rigidity of the projections 66, 67 is increased compared to the configuration in which the projections are mounted on the surface of the trim body member. Therefore, in this embodiment, the net member 40 can be held more securely.

The trim body member 21 includes the first recessed portion 22 on the compartment interior side surface 21A of the trim body member 21 and the first recessed portion 22 opens toward the net member 40. The net member 40 is disposed to cover at least a portion of the first recessed portion 22. The first recessed portion 22 is a portion of the trim body member 21 that is recessed toward the reinforcing member 60. The reinforcing member 60 includes the fitting recessed portion 64 that is fitted to at least a portion of the first recessed portion 22.

With the trim body member 21 including the first recessed portion 22, the space between the net member 40 and the trim body member 21 can be increased by the depth (a recessed dimension) of the first recessed portion 22. Therefore, a large item can be stored in the space between the net member 40 and the trim body member 21. With the trim body member 21 including the first recessed portion 22, the rigidity of the trim body member 21 can be further increased. Furthermore, with the reinforcing member 60 including the fitting recessed portion 64 to which a portion of the first recessed portion 22 is fitted, the rigidity of the reinforcing member 60 can be further increased and the first recessed portion 22 can be reinforced more surely.

The trim body member 21 includes the second recessed portion 23 on the compartment interior side surface 21A. The net member 40 is attached to the second recessed portion 23. Accordingly, the surface of the net member 40 and the compartment interior side surface 21A of the trim body member 21 are likely to be on the same plane and this improves the design.

### Other embodiments

The technology described herein is not limited to the embodiment described above with reference to the drawings. The technical scope of the present disclosure may include the following embodiments and all modifications in the scope of claim or its equivalent scope.

(1) In the above embodiment, the room partition trim is described as one example of the vehicular interior components. However, the present technology may be applied to vehicular interior components other than the room partition trim (such as a door trim, a deck side trim, a pillar garnish) and vehicular interior components of an aircraft and ships.

(2) The shape of the first recessed portion 22 may be altered as appropriate from the one described in the above embodiment. The shapes of the net member 40 and the second recessed portion 23 may be altered as appropriate from those described in the above embodiment.

(3) The number and the shapes of the projections 66, 67 may be altered as appropriate from those described in the above embodiment.

1. A vehicular interior component comprising:
an interior component body member having a plate shape and including a compartment interior side surface, a compartment exterior side surface, and through holes;
a net member disposed on the compartment interior side surface of the interior component body member; and
a reinforcing member mounted on the compartment exterior side surface of the interior component body member, the reinforcing member including
a reinforcing body portion having an interior component body side surface that faces the interior component body, and
projections that project from the interior component body side surface toward the interior component body member and are inserted through the through holes of the interior component body member,
the projections including stopper portions at projecting end portions of the projections and the stopper portions being on a compartment interior side with respect to the interior component body member and holding the net member.

2. The vehicular interior component according to claim 1, wherein
the interior component body member includes a recessed portion on the compartment interior side surface and the recessed portion is a portion of the interior component body member that is recessed toward the reinforcing member and opens toward the net member,
the net member is disposed to cover at least a portion of the recessed portion, and
the reinforcing member includes a fitting recessed portion to which at least a portion of the recessed portion is fitted.

3. The vehicular interior component according to claim 1, wherein the reinforcing member integrally includes the projections.

4. The vehicular interior component according to claim 1, wherein
the projections include base portions and projecting end portions,
the base portions extend continuously from the reinforcing body portion and the projecting end portions extend continuously from the base portions, and
the projecting end portions include the stopper portions.

5. The vehicular interior component according to claim 1, wherein the reinforcing body portion of the reinforcing member is on a compartment exterior side with respect to the interior component body member.

6. The vehicular interior component according to claim 2, wherein the fitting recessed portion of the reinforcing member overlaps and is contacted with the at least the portion of the recessed portion.
